(19) United States
(12) Patent Application Publication
(10) Pub. No.: US 2021/0277336 A1
(43) Pub. Date: Sep. 9, 2021

(54) COMPOSITION AND PROCESS FOR OIL REMOVAL FROM FABRICS HAVING A WITH WATER REPELLANT COATING

(71) Applicant: Green Theme Technologies Inc., Rio Rancho, NM (US)

(72) Inventors: Gary S. Selwyn, Albuquerque, NM (US); Chris B. Cooper, Albuquerque, NM (US); Aaron T. Caudill, Albuquerque, NM (US)

(21) Appl. No.: 17/193,288

(22) Filed: Mar. 5, 2021

Related U.S. Application Data
(60) Provisional application No. 62/985,387, filed on Mar. 5, 2020.

(51) Int. Cl. C11D 17/00; C11D 11/00; C11D 3/37; C11D 3/22; C11D 1/722; C11D 1/29; C11D 3/00

(52) U.S. Cl. CPC C11D 17/0021; C11D 11/0017; C11D 3/373; C11D 3/0036; C11D 1/722; C11D 1/29; C11D 3/222

(57) ABSTRACT

A cleaning composition for removing oil stains from fabrics is an oil-in-water emulsion containing a silicone oil having at least 5 silicon atoms and a vapor pressure of at most 0.05 kPa at 25° C., at least one poly(dimethyl siloxane) having up to 2 to 4 silicon atoms and a vapor pressure of at least 0.25 kPa at 25° C., and an emulsifier. The cleaning composition is useful for removing oil stains from fabrics that have an applied hydrophobic coating. The cleaning composition effectively removes the oil stains with little adverse affect, and sometimes even a beneficial effect, on the water-repellency of the fabric.

The present invention relates generally to a means for removing oils and oil stains from a fabric coated with a water repellant coating.

WO2015/127479 and WO2017/020018 describe compositions and processes for applying hydrophobic coatings to textiles. The hydrophobic coating composition is a room temperature liquid or suspension of solid particles in a liquid. Some embodiments include certain free-radical polymerizable monomers, crosslinkers, a heat- or UV-activated free radical initiator and a silicone oil and/or wax. The monomers contain long-chain hydrocarbyl groups that may be non-fluorinated, partially fluorinated or perfluorinated. The composition is cured, or polymerized, in the presence of free radicals and in a low oxygen environment to produce the desired hydrophobic coating. These coatings exhibit excellent water-repellency and durability.

Many current water-repellent products, including those made in accordance with WO2015/127479 and WO2017/020018, are being made without fluorinated monomers or other fluorocarbons because of environmental and health concerns regarding the use of fluorocarbons. Unfortunately, these fluorocarbon-free coatings are more susceptible to staining by oily materials than repellent coatings that contain fluorocarbons. Staining often occurs during garment manufacturing, such as by contamination by sewing machine oils or other lubricants, or during use, such as by foods, skin oils or other household, consumer or industrial products. The oily stains have been found to be difficult to remove from the treated fabrics and may affect the water repellency performance of garments made with these fabrics. In addition, it has been found that treatments that remove the oily stain often also impair the function of the hydrophobic coating, rendering the fabric less water-repellent. An effective way of removing oily stains from such treated fabrics would be desired, especially one that does not degrade the product water repellency performance.

This invention is in one aspect a fabric cleaning composition in the form of an oil-in-water emulsion, the fabric cleaning composition comprising
a) water;
b) a silicone oil having at least 5 silicon atoms and a vapor pressure of at most 0.05 kPa at 25° C.;
c) at least one poly(dimethyl siloxane) having up to 2 to 4 silicon atoms and a vapor pressure of at least 0.25 kPa at 25° C.;
d) an emulsifier.

The invention is also a method for removing oil stains from a fabric having a water-repellant coating, comprising

a) providing an oil-stained fabric, the fabric having a water-repellant coating, the water-repellent coating comprising a crosslinked polymer of at least one free-radical-curable monomer having at least one hydrocarbyl group that has at least eight carbon atoms, wherein the hydrocarbyl group may be nonfluorinated, partially fluorinated or perfluorinated;

b) applying a fabric cleaning composition of claim 1 to the oil stain;

c) removing at least a portion of the applied fabric cleaning composition from the fabric, together with at least a portion of the oil stain, whereby at least a portion of the silicone oil contained in the fabric cleaning composition remains on the fabric.

The composition and process of the invention have been found to be very effective in removing oily stains from the fabric, without diminishing and in some cases restoring the water-repellency properties. It is believed that residual silicone oil remains on the fabric after the oil removal process is completed, and that this residual silicone oil imparts water repellency after the oil stain has been removed.

The fabric cleaning composition includes water. Water is generally present in an amount sufficient to provide a continuous aqueous phase. Water may constitute, for example, at least 30%, at least 50% or at least 70% of the volume of the fabric cleaning composition. Water may constitute, for example, up to 98%, up to 95% or up to 92% of the volume of the fabric cleaning composition.

The silicone oil having at least 5 silicon atoms and a vapor pressure of at most 0.05 kPa at 25° C. is a hydrophobic material that may constitute, for example, 0.25 to 50% by volume of the fabric cleaning composition. In some embodiment, this silicone oil constitutes at least 1% or at least 2% by volume of the fabric cleaning composition and up to 30%, up to 25%, up to 15%, up to 10% or up to 7.5% on the same basis.

The silicone oil is a room temperature (23°) liquid. It contains at least 5 silicon atoms and has a vapor pressure of at most 0.05 kPa at 25° C. The silicone oil may be a linear or branched polydimethylsiloxane (PDMS) oil or linear or branched polymethylhydrosiloxane (PMHS) oil. The silicone oil may have a kinematic viscosity of at least 1 and up to 300 centistokes at 25° C. (as measured according to ASTM D4283-98 (2015). A preferred silicone oil is a linear or poly(dimethyl siloxane) having a kinematic viscosity of 1 to 50, especially 2 to 25, centistokes at 25° C. A mixture of two or more such silicone oils may be present in the fabric cleaning composition.

The fabric cleaning composition contains at least one poly(dimethyl siloxane) having up to 2 to 4 silicon atoms and a vapor pressure of at least 0.25 kPa at 25° C. Examples of such poly(dimethyl siloxane)s include hexamethyl disiloxane, octahexyl trisiloxane and pentamethyl tetrasiloxane. A mixture of two or more such poly(dimethyl siloxane)s is useful. A mixture of hexamethyldisiloxane and octamethyltrisiloxane is useful; such a product is available commercially from The Dow Chemical Company as OS-2 Silicone Cleaner and Solvent. This poly(dimethyl siloxane) having up to 2 to 4 silicon atoms and a vapor pressure of at least 0.25 kPa at 25° C. may constitute, for example, at least 0.25%, at least 1% or at least 2% and up to 50%, up to 30%, up to 25%, up to 15%, up to 10% or up to 7.5% by volume of the fabric cleaning composition.

The fabric cleaning composition contains an emulsifier, which is a surfactant that emulsifies the silicone oil into the aqueous phase to produce an emulsion. Various anionic, nonionic, cationic and zwitterionic surfactants are useful, including, for example, sorbitan esters such as sorbitan monooleate, sorbitan stearate, sorbitan laurate, sorbitan sesquioleate, sorbitan tristearate, sorbitan palmitate, and sorbitan trioleate; ethoxylated and esterified sorbitans such as polysorbate 20, polysorbate 60, and polysorbate 80; ethoxylates of fatty acids; ethoxylates of fatty alcohols; propylene oxide/ethylene oxide block copolymers; ethoxylated amines; ethoxylated fatty acid amides, poloxamers, mono- and di-fatty acid ester of glycerol such as glycerol monostearate and glycerol monolaurate; alkylphenol ethoxylates; benzyl alcohol sulfates and sulfonates; linear alkylbenzene sulfonates; alcohol ethoxy sulfates and sulfonates; alkyl polyglucosides; amine oxides; fatty acid sodium salts; diacylated fatty acid monoglycerides, and the like. Mixtures that include at least one anionic surfactant and at least one nonionic surfactant are useful; such a mixture may contain at least one sulfate or sulfonate surfactant (such as an alcohol ethoxyl sulfate and/or linear alkylbenzene sulfonate) and at least one alcohol ethoxylate. The surfactant(s), when present, may constitute 0.005% to 5% of the total volume of the fabric cleaning composition. A preferred amount is at least 0.01% or at least 0.025% and up to 2% up to 1% or up to 0.5%, on the same basis. Commercially available surfactant mixtures such as liquid laundry detergents are useful for this purpose.

The fabric cleaning composition may contain other ingredients such as fragrances, rheology modifiers, pH modifiers, chelating agents, thickening agents (such as xanthan gum, locust bean gum or guar gum) and bleaching agents.

The fabric cleaning composition is useful for removing oil stains from fabrics, in particular fabrics that have a water repellent coatings that comprise a crosslinked polymer of at least one free-radical-curable monomer having at least one hydrocarbyl group that has at least eight carbon atoms, wherein the hydrocarbyl group may be nonfluorinated, partially fluorinated or perfluorinated. In certain embodiments, the coating lacks fluorine, in which case the hydrocarbyl group of the free-radical-curable monomer is nonfluorinated. Non-fluorinated water repellent coatings are particularly susceptible to oil staining and therefore the ability to remove oil from fabrics so coated is a particular advantage of this invention. Included among such fabrics are those having a water-repellent coating as described in WO 2015/127479 and WO 2017/020018, in particular those in which the coating is a crosslinked polymer of nonfluorinated monomer(s).

The water repellent coating preferably includes at least one of (a) a silicone oil having at least 5 silicon atoms and a vapor pressure of at most 0.05 kPa at 25° C. (such as is described above) and (b) a wax, such as a polyethylene wax, bees wax, lanolin, carnauba wax, candelilla wax, ouricury wax, sugarcane wax, jojoba wax, epicuticular wax, coconut wax, petroleum wax, paraffin wax and the like. The water-repellent coating most preferably includes a silicone oil.

The crosslinked polymer in some embodiments is a polymer coating prepared by polymerizing (i) at least one fatty acid acrylate having 10 to 16 carbon atoms in the fatty acid group, (ii) one or more of an alkane diol diacrylate, a pentaerythritol or dipentaerythritol polyacrylate and a drying oil such as linseed, safflower or tung oil, and optionally (iii) at least one fatty acid acrylate having at least 18 carbon atoms in the fatty acid group. Such a polymerization is preferably performed by forming a coating composition containing the foregoing monomers, a silicone oil having at least 5 silicon atoms and a vapor pressure of at most 0.05 kPa at 25° C., and optionally a wax as described before. The coating so produced may contain all or a portion of the silicone oil and wax (if used) dissolved in or otherwise embedded in the polymer coating.

The fabric is made of up fibers that are, for example, woven, knitted, entangled, knotted, felted, glued or otherwise formed into a textile. Such a fabric includes fibers that may be, for example, a natural fiber such as cotton, hemp, wool, linen, silk, tencel, rayon, bamboo, cellulose and the like, or a synthetic fiber such as nylon, aramid, polypropylene, polyester (including PET), polyacetate, polyacrylic, polylactic acid, cellulose ester or other fiber and blends of any two or more of the above. It may a smooth or fleeced fabric and it may contain a stretchable fiber, such as Elastane, Lycra, or Spandex. It has been found that the process of the invention is particularly well-adapted for use with fabrics that have an equilibrium moisture content of no greater than 15% by weight (especially no greater than 10% or no greater than 5%) after exposure to 65±2% relative humidity air at 20±2° C. until a constant moisture content is obtained. The moisture content is determined by weighing the conditioned sample, then drying it at 105±2° C. (110±2° C. for acrylic fibers, 77±2° C. for chlorofibers) until a constant weight is obtained. The moisture content is calculated as

$$MC = 100 \% \times \frac{{Mass}_{Conditioned} - {Mass}_{Dried}}{{Mass}_{Dried}}$$

wherein Mass_{conditioned} is the weight of the conditioned sample and Mass_{Dried} is the mass of the oven-dried sample.

Polyester and polyamide (nylon) fabrics are of particular interest as the benefits of the invention are particularly pronounced when such fabrics are cleaned in accordance with the invention.

The fabric preferably is characterized in having an air permeability of at least 25 cubic foot/minute/square foot as measured according to ASTM D737, using a Textest FX 3300 instrument and a 38 cm² test area. More preferably, the porous fabric has an air permeability of at least 50, at least 75, at least 100 or at least 130 cubic feet/minute/square foot. The air permeability of the porous fabric may be any higher value, such as up to 300 cubic feet/minute/square foot.

An oil stain is one produced due to the fabric being contacted with a non-silicone oil. “Oil” in this context is taken to mean a hydrophobic, non-silicon-containing compound having at least 10 carbon atoms and which has a melting temperature of up to 50° C., or a mixture of two or or more such compounds. Examples of such oils include alkanes (linear, branched and/or cyclic) having 10 or more carbon atoms, especially 10 to 75 or 14 to 55 carbon atoms; alkylated benzenes; hydrocarbon mixtures such as mineral oil, motor oil, diesel oil, No. 2 oil, light crude oils, crude oil, IFO 80 oil, heavy crude oil, No. 6 fuel oil, bunker oil, slurry oils, residual oils, as well as other industrial and sewing machine oils, and the like; plant and animal oils or fats such as vegetable oil, canola oil, olive oil, avocado oil, grapeseed oil, flaxseed oil, coconut oil, peanut oil, sesame oil, safflower oil, hemp seed oil, walnut oil, almond oil, palm oil, sunflower oil, corn oil, butter, beef tallow, lard, chicken fat, other animal fats; synthetic esters of fatty acids and/or fatty alcohols, which esters have 10 or more, especially 15 or more, carbon atoms, including synthetic motor oils and lubricants; and the like.

The oil-stained fabric is cleaned by applying the fabric cleaning composition of the invention to the oil stain, followed by removing at least a portion of the applied fabric cleaning composition from the fabric together with at least a portion of the oil stain, whereby at least a portion of the silicone oil contained in the fabric cleaning composition remains on the fabric.

The step of applying the fabric cleaning composition can be performed in any convenient manner that brings the fabric cleaning composition into contact with the oil stain. The fabric cleaning composition can simply be poured onto the stain. Alternatively it may be applied to a sponge, brush, roller, cloth or other substrate and then transferred to the oil-stained fabric by rubbing or brushing. The fabric cleaning composition can take the form of a liquid or a gel. As applied the fabric cleaning composition contains at most 95%, preferably at most 92% water by volume, it preferably is not further diluted with water before or during the cleaning process.

At least a portion of the fabric cleaning composition is then removed from the fabric. The method of removal is not particularly critical. The fabric cleaning composition can be removed by rubbing or brushing with a sponge, brush, roller, cloth or other substrate. The fabric can be rinsed in water, washed in water, dry cleaned or otherwise laundered to remove the fabric cleaning composition.

The fabric cleaning composition can be formulated with one or more thickening agents to produce a gel or stick. Such a gel or stick can be physically rubbed onto the oil stain, penetrating the stain under mechanical pressure such as the rubbing step itself (especially for temperature-sensitive fabrics such as wool or silk) or, for example, a subsequent ironing step. The fabric cleaning composition and oil stain can be removed, by and/or machine washing for example.

At least a portion of the oil stain is removed along with the removal of the fabric cleaning composition. An advantage of the invention is that oil stains are very effectively removed from fabrics that have a water-repellent coating as described herein and in WO 2015/127479 and/or WO2017/020018, particularly when the coating includes a polymer of a non-fluorinated monomer.

A further advantage of this invention is that, unlike the case when the fabric is cleaned using other types of cleaners, there is little or no adverse effect on the water-repellent properties of the fabric. It is believed that at least some of the silicone oil having at least 5 silicon atoms and a vapor pressure of at most 0.05 kPa at 25° C., present in the fabric cleaning composition, remains with the fabric after the stain removal process has been completed, contributing to the water-repellency of the fabric after the oil stain has been removed.

Cleaning of oil-stained fabrics that are coated with a coating as described in WO2015/127479 and WO2017/020018 using the technique described herein, does not decompose the coating. It is believed that such a coating reabsorbs a portion of the silicone oil in the fabric cleaning composition, which thereby contributes to the hydrophobicity of the cleaned fabric. Conventional oil-stain removal solvents such as methyl ethyl ketone, are prone to attacking and decomposing such a coating.

Still better results can be obtained by subjecting the fabric to heat and superatmospheric pressure after the oil stain has been removed. This is conveniently accomplished by dry or steam ironing the fabric using a temperature of 100 to 220° C. (as suitable for the particular fabric). The superatmospheric pressure may be mechanical and/or gas or steam pressure. Heat and mechanical pressure can be applied by ironing the fabric using a heated iron. Alternatively, this can be accomplished by applying liquid water to the fabric and heating the moistened and coated fibrous substrate to volatilize the water and produce steam at superatmospheric pressure in contact with the fabric.

The following examples are intended to illustrate the invention but not to limit the scope thereof. All parts and percentages are by weight unless otherwise indicated.

### Examples 1 and 2 and Comparative Samples A-C

A Marmot blue JYRNP0002 woven polyester fabric is treated with a water-repellent coating in the general manner described in WO 2017/020018 Example 1. A free-radical polymerization reaction is used to produce the water-repellent, hydrocarbon-based coating from a mixture containing octadecyl acrylate, 1,6-hexanediol diacrylate, dipentaerythritol penta-/hexaacrylate, lauroyl peroxide and a 10 centistoke polydimethylsiloxane. The mixture and the resultant polymer coating does not contain fluorine.

Five identical swatches of the treated fabric are stained with a weighed quantity of Singer sewing machine oil and air-dried. A sixth swatch is unstained and used as a control.

To produce Example 1, a stained swatch is cleaned using a fabric cleaning composition of the invention, containing 900 mL water, 50 mL of a mixture of hexamethyldisiloxane and octamethyltrisiloxane (OS-2, from The Dow Chemical Company), 25 mL of a 5 centistoke poly(dimethylsiloxane) oil, 25 mL of a 10 centistoke poly(dimethylsiloxane) oil and 0.5 mL of Tide® liquid laundry detergent. The laundry detergent includes an alcohol ethoxylate surfactant, an alkyl ethoxy sulfate surfactant, an alkyl sulfate surfactant and an amine oxide surfactant. The fabric cleaning composition is rubbed onto the stained swatch, then rinsed with water and air-dried. The stain is entirely removed.

Example 2 is cleaned in the same manner as Example 1, and then steam-ironed by hand using a hot iron at an appropriate setting for a polyester fabric.

Comparative Sample A is the unstained swatch.

Comparative Sample B is prepared rubbing methyl ethyl ketone onto a stained swatch, then rinsing and air-drying. The stain is entirely removed.

Comparative Sample C is prepared by rubbing Tide® detergent onto a stained swatch, then rinsing and air-drying. The stain is entirely removed.

Examples 1 and 2 and Comparative Samples A-C are then evaluated according to the 30-second AATCC 22 spray test and for water repellency according to ISO 9865, for 10 minutes in a Bundesmann water repellency tester. Results are as indicated in the following Table. Higher ratings on the AATCC 22 spray test and the ISO 9865 test each indicate better results. The AATCC spray test scale ranges from 0 to 100 (best) and the ISO 9865 water repellency test ranges from 1 to 5 according to a visual scale with 5 being the best.

TABLE

| | | | AATCC 22 | | ISO9865, |
|---|---|---|---|---|---|
| Desig- | Descrip- | Appear- | Spray Test | ISO9865 | % water |
| nation | tion | ance | Rating | rating | pickup |
| A* | Unstained | Clean | 100 | 4.7 | 2.4 |
| | Control | (not | | | |
| | | stained) | | | |
| B* | Stained, not | Badly | 95 | 2.6 | 9.9 |
| | cleaned | stained | | | |
| C* | Cleaned with | Stain | 80 | 1 | 23.9 |
| | MEK | removed | | | |
| D* | Cleaned with | Stain | 80 | 1 | 31.2 |
| | Detergent | removed | | | |
| 1 | Cleaned per | Stain | 95 | 3.5 | 17.6 |
| | the invention | removed | | | |
| 2 | Cleaned per | Stain | ND | 4.4 | 16.0 |
| | the invention | removed | | | |
| | and then | | | | |
| | ironed. | | | | |

As the data in the foregoing table shows, the mineral oil badly stains the swatch, even with the water-repellent coating. Some deterioration in performance in the AATCC 22 and ISO9865 tests is seen, but performance remains fair to good on these tests due to the water-repellent nature of the sewing machine oil used to stain the swatch.

Cleaning with methyl ethyl ketone or Tide detergent leads to a large loss in performance on both the AATCC 22 and ISO9865 tests. Despite being effective cleaners, these cleaning agents have a serious adverse effect on water-repellency.

Example 1 is not only cleaned of the stain, but exhibits AATCC 22 and ISO9865 ratings much better than the stained sample and the samples cleaned with methyl ethyl ketone or the detergent. Results on the AATCC 22 and ISO9865 tests are nearly as good as those of the unstained sample. After ironing, the ISO0865 rating improves even more. Similarly, Example 2 is cleaned of the stain and nearly attains the ISO 9865 rating of the unstained control.

What is claimed is:

1. A fabric cleaning composition in the form of an oil-in-water emulsion, comprising
a) water;
b) a silicone oil having at least 5 silicon atoms and a vapor pressure of at most 0.05 kPa at 25° C.;
c) at least one poly(dimethyl siloxane) having up to 2 to 4 silicon atoms and a vapor pressure of at least 0.25 kPa at 25° C.;
d) an emulsifier.

2. The fabric cleaning composition of claim 1 wherein the silicone oil has a kinematic viscosity of at least 1 and up to 300 centistokes at 25° C. (as measured according to ASTM D4283-98 (2015).

3. The fabric cleaning composition of claim 2 wherein the silicone oil a linear or poly(dimethyl siloxane) having a kinematic viscosity of 2 to 25 centistokes at 25° C. (as measured according to ASTM D4283-98 (2015).

4. The fabric cleaning composition of claim 1 wherein the poly(dimethyl siloxane)s having up to 2 to 4 silicon atoms and a vapor pressure of at least 0.25 kPa at 25° C. include one or more of hexamethyl disiloxane; octahexyl trisiloxane, and pentamethyl tetrasiloxane.

5. The fabric cleaning composition of claim 1 wherein the poly(dimethyl siloxane)s having up to 2 to 4 silicon atoms and a vapor pressure of at least 0.25 kPa at 25° C. include a mixture of hexamethyldisiloxane and octamethyltrisiloxane.

6. The fabric cleaning composition of claim 1 wherein the emulsifier includes at least one nonionic surfactant and at least one nonionic surfactant.

7. The fabric cleaning composition of claim 6 wherein the emulsifier includes at least one sulfate or sulfonate surfactant and at least one alcohol ethoxylate surfactant.

8. The fabric cleaning composition of claim 1 further comprising a thickener.

9. The fabric cleaning composition of claim 8 wherein the thickener agent includes at least one of xanthan gum, locust bean gum or guar gum.

10. The fabric cleaning composition of claim 1 which contains 50 to 95 volume-% water, 1 to 15 volume-% of the silicone oil, 1 to 7.5 volume-% of the poly(dimethyl siloxane) having up to 2 to 4 silicon atoms and a vapor pressure of at least 0.25 kPa at 25° C. and 0.005 to 2% volume % of the emulsifier.

11. A method for removing oil stains from a fabric having a water-repellant coating, comprising
a) providing an oil-stained fabric, the fabric having a water-repellant coating, the water-repellent coating comprising i) a crosslinked polymer of at least one free-radical-curable monomer having at least one hydrocarbyl group that has at least eight carbon atoms, wherein the hydrocarbyl group may be nonfluorinated, partially fluorinated or perfluorinated, and ii) a silicone oil having at least 5 silicon atoms and a vapor pressure of at most 0.05 kPa at 25° C.;
b) applying to the oil stain a fabric cleaning composition of claim 1;
c) removing at least a portion of the applied fabric cleaning composition from the fabric, together with at least a portion of the oil stain.

12. The method of claim 11 wherein the hydrocarbyl group is nonfluorinated.

13. The method of claim 12 wherein the water-repellant coating does not contain fluorine.

14. The method of claim 13 wherein the water-repellent coating is a polymer of a coating composition comprising (i) at least one fatty acid acrylate having 10 to 16 carbon atoms in the fatty acid group, (ii) one or more of an alkane diol diacrylate, a pentaerythritol or dipentaerythritol polyacrylate and a drying oil such as linseed, safflower or tung oil, and optionally (iii) at least one fatty acid acrylate having at least 18 carbon atoms in the fatty acid group.

15. The method of claim 14 wherein the coating composition further contains a silicone oil having at least 5 silicon atoms and a vapor pressure of at most 0.05 kPa at 25° C., and optionally a wax.

16. The method of claim 11 wherein the fabric has an equilibrium moisture content of no greater than 15% by weight (especially no greater than 10% or no greater than 5%) after exposure to 65±2% relative humidity air at 20±2° C. until a constant moisture content is obtained.

17. The method of claim 11 wherein the fabric is a polyester or polyamide fabric, or a polyester/polyamide blend or a blend one or more of a polyester and a polyamide with an elastomer fiber.

18. The method of claim 11 further comprising d), after step c), drying the fabric by heat, evaporation or spinning.
